(19) United States
(12) Patent Application Publication
(10) Pub. No.: US 2025/0375960 A1
(43) Pub. Date: Dec. 11, 2025

(54) MULTILAYER PACKAGING FILMS

(71) Applicant: AMCOR FLEXIBLES NORTH AMERICA, INC., Neenah, WI (US)

(72) Inventors: Philipp OKLE, Konstanz (DE); Peter ETTRIDGE, Worcester (GB); Wolfgang LOHWASSER, Gailingen (DE); Roy CHRISTOPHERSON, Shrivenham (GB)

(21) Appl. No.: 18/873,671

(22) PCT Filed: Jun. 24, 2022
(86) PCT No.: PCT/US2022/034810

§ 371 Date: Dec. 10, 2024

(51) Int. Cl. B32B 27/32; B32B 7/12; B32B 27/08

(52) U.S. Cl. CPC B32B 27/32; B32B 7/12; B32B 27/08; B32B 2250/03; B32B 2250/242; B32B 2255/06; B32B 2255/10; B32B 2260/046; B32B 2307/31; B32B 2307/518; B32B 2307/7244; B32B 2307/736; B32B 2323/10

(57) ABSTRACT

This disclosure concerns a multilayer packaging film having a first base layer, a second base layer on the first base layer, and a sealing layer on the second base layer. In some embodiments, a shrinkage value of the second base layer is less than a shrinkage value of the first base layer. In some embodiments, the shrinkage value of the second base layer is greater than or equal to a shrinkage value of the first base layer. In some embodiments, the second base layer has a shrinkage value that is greater than 5%, and the shrinkage value of the second base layer is less than a shrinkage value of the first base layer. Also disclosed are methods of producing multilayer packaging films and hermetically sealed packages (e.g., thermoformed trays or cups and retort pouches) formed from the multilayer packaging film.

### TECHNICAL FIELD

The present invention is related to multilayer film structures. Embodiments of the present invention are directed to flexible multilayer films for packaging applications.

### BACKGROUND

A typical packaging application involving the exposure of a multilayer film structure to thermal stress is retort packaging. In retort packaging, the packaged product undergoes an extended heat and pressure treatment process. Similarly, packaging or a packaged product may undergo a pasteurization process at about 80° C. In still another application, multilayer film structures may be used as a thermal shrink wrap foil at temperatures of 80° C. or lower.

Food products are increasingly being packaged in flexible retort packages (i.e., flexible stand-up pouches) as an alternative to metal cans and glass jars. The packaging material for flexible retort packages typically includes an embedded barrier layer, an outer polymer layer adhered to one side of the barrier layer and forming the exterior surface of the package, and an inner polymer film layer adhered to the other side of the gas barrier layer and forming the interior surface of the package. This combination of layers is designed to withstand a retort process without melting or substantially degrading (i.e., leaking, delaminating). In general, retorting consists of heating the packaging container to a temperature in a range of from 100 to 135° C., at an overpressure in a range of from 0.5 to 1.1 bar, for a time period in a range of from 15 to 100 minutes.

Examples of laminates for retort packaging are disclosed in U.S. Pat. Nos. 4,310,578 A; 4,311,742 A; 4,308,084 A; 4,309,466 A; 4,402,172 A; 4,903,841 A; 5,273,797 A; 5,731,090 A; EP 1 466 725 A1; JPH 09 267 868 A; JP 2002 096 864 A; JP 2015 066 721 A; JP 2018 053 180 A; JP 2017 144 648 A; JPS 62 279 944 A; JPS 6 328 642 and JPH 10 244 641 A.

One typical option for designing resilient retort packaging multilayer film structures is the use of an aluminum barrier layer having a thickness of at least 5 μm, preferably more than 12 μm thickness. Nevertheless, aluminum is expensive, of high density, subject to pinholes at lower thicknesses after flexing, and has the drawback of opacity. Aluminum is also known to cause problems for reheating a packaged food product in a microwave oven. Moreover, the presence of a metal layer is, in general, undesirable in terms of recycling possibilities and metal detection within the packaging process.

A typical example of a multilayer film structure for standard retort pouches comprises a polyethylene terephthalate exterior layer, a barrier layer, and an inner sealing layer, wherein the exterior layer comprises a printing layer, the barrier layer comprises a metal foil, or an inorganic oxide coated polymer film and the inner layer is a heat sealable polyolefin layer. The packaging material may also contain an additional polymer film layer such as a polyamide layer or the like.

The diversity of the polymer layers composing the multilayer barrier film structure results in an additional challenge for rendering these multilayer film structures recyclable and able to withstand a retort process without melting or substantially degrading (i.e., leaking, delaminating).

Without contesting the associated advantages of the state-of-the-art systems, there exists a need for improved multilayer film structures for packaging, wherein the multilayer film structure is recyclable and able to withstand a retort process without melting or substantially degrading (i.e., leaking, delaminating).

### SUMMARY

Embodiments of the present invention advantageously provide multilayer packaging films that are able to withstand a retort process without melting or substantially degrading (i.e., leaking, delaminating). In some embodiments, the multilayer packaging film structure is heat treated, for example, during a pasteurization or a retort treatment. In some embodiments, the multilayer packaging film structure comprises one or more inorganic coating layers remaining substantially crack-free during and after the heat treatment, thereby limiting the increase of oxygen and water vapor transmission rate of the multilayer packaging film.

Additional embodiments of the present invention advantageously provide a more sustainable, transparent multilayer packaging film showing outstanding oxygen transmission rate (low transmission, high barrier) that is heat resilient, the heat resilient multilayer packaging film structure being relatively easier to recycle than typical high barrier packaging film structures.

The disclosure provides multilayer packaging films having a first base layer, a second base layer on the first base layer, and a sealing layer on the second base layer. In some embodiments, one or more of the first base layer, the second base layer, or the sealing layer comprise a polyolefin film.

In some embodiments, the polyolefin film of each of the first base layer and the second base layer is an oriented polyethylene (OPE) film or an oriented polypropylene (OPP) film. In some embodiments, one or more of the oriented polyethylene (OPE) film or the oriented polypropylene (OPP) film is formed by one or more of a sequential stretching process or a simultaneous stretching process. In some embodiments, the simultaneous stretching process is one or more of a linear motor simultaneous stretching process, a double bubble process, or a triple bubble process.

In some embodiments, the oriented polypropylene (OPP) film is a coextruded OPP film having a first side that is treated and not sealable and a second side that is sealable.

In some embodiments, the oriented polypropylene (OPP) film is a coextruded OPP film having a first side that is treated and not sealable and a second side that is treated and not sealable.

In some embodiments, the polyolefin film comprises a biaxially oriented polypropylene (BOPP) film. In some embodiments, the biaxially oriented polypropylene (BOPP) film is formed by a linear motor simultaneous stretching process, the biaxially oriented polypropylene (BOPP) film having a first side that is treated and not sealable and a second side that is sealable. In some embodiments, the biaxially oriented polypropylene (BOPP) film is formed by a triple bubble process, the biaxially oriented polypropylene (BOPP) film having a first side that is treated and not sealable and a second side that is sealable.

In some embodiments, one or more of the first base layer or the second base layer have an inorganic coating layer thereon. The inorganic coating layer may be on one or more sides of the first base layer and/or the second base layer. In some embodiments, the inorganic coating of one or more of the first base layer or the second base layer comprises silicon oxide. In some embodiments, the inorganic coating of one or more of the first base layer or the second base layer has a gas barrier coating thereon. In one or more embodiments, the gas barrier coating comprises one or more of a hydroxyl group-containing polymer compound, a metal alkoxide, a silane coupling agent, and hydrolyzates thereof. In some embodiments, the inorganic coating layer improves gas barrier performance of one or more of the first base layer or the second base layer against water vapor and oxygen.

Some embodiments of the multilayer packaging film further comprise an adhesive layer on one or more of the first base layer, the second base layer or the sealing layer. In one or more embodiments, the adhesive layer comprises polyurethane. In some embodiments, the adhesive layer comprises one or more of polyester-based polyurethane resins or polyether-based polyurethane resins.

In some embodiments, the adhesive layer comprises a polyvinyl alcohol-based resin that has a vinyl alcohol unit in which a vinyl ester unit is saponified, and examples thereof include polyvinyl alcohol (PVA) and an ethylene-vinyl alcohol copolymer (EVOH).

In some embodiments, the adhesive layer is heat-resistant and provides adhesion to each layer that the adhesive layer is in contact with.

In some embodiments, the adhesive layer is located between one or more of the first base layer and the second base layer, or the second base layer and the sealing layer. In some embodiments, the adhesive layer is located between one or more of the first base layer and the inorganic coating thereon, between the second base layer and the inorganic coating thereon, or between the inorganic coating on the second base layer and the sealing layer.

In embodiments where the multilayer packaging film comprises the inorganic coating, the adhesive layer may be located on the surface of the polyolefin film on which the inorganic coating layer is laminated. Without intending to be bound by theory, in such embodiments, it is thought that the adhesive layer improves adhesion between the polyolefin film and the inorganic coating layer and improves the smoothness of the surface of the polyolefin film.

In one or more specific embodiments, the multilayer packaging film comprises a first base layer and a second base layer, each having an inorganic coating layer thereon. In one or more specific embodiments, the adhesive layer is between and in direct contact with the first base layer and the inorganic coating layer that is on the first base layer. In one or more specific embodiments, the adhesive layer is between and in direct contact with the second base layer and the inorganic coating layer that is on the second base layer. In one or more specific embodiments, the sealing layer is on the inorganic coating layer that is on the second base layer.

In some embodiments, the multilayer packaging film has a total composition including greater than or equal to 80% polyolefin, greater than or equal to 90% polyolefin or greater than or equal to 95% polyolefin, by weight. In some embodiments, the multilayer packaging film has a total composition including greater than or equal to 80% polypropylene, greater than or equal to 90% polypropylene or greater than or equal to 95% polypropylene, by weight. In some embodiments, the multilayer packaging film has a total composition including greater than or equal to 80% polyethylene, greater than or equal to 90% polyethylene or greater than or equal to 95% polyethylene, by weight.

In some embodiments, a shrinkage value of the second base layer is less than a shrinkage value of the first base layer. In some embodiments, the shrinkage value of the second base layer is greater than or equal to a shrinkage value of the first base layer. In some embodiments, the second base layer has a shrinkage value that is greater than 5%, and the shrinkage value of the second base layer is greater than a shrinkage value of the first base layer. In some embodiments, the second base layer has a shrinkage value that is less than or equal to 5%. In some embodiments, the shrinkage value of the second base layer is greater than or equal to a shrinkage value of the sealing layer.

In some embodiments, the difference in shrinkage value of the first base layer and the second base layer is greater than or equal to 0.3%. In some embodiments, the difference in shrinkage value of the second base layer and the sealing layer is greater than or equal to 0.5%. In some embodiments, the shrinkage value of the sealing layer is greater than or equal to 2%.

In some embodiments, each of the first base layer and the second base layer have a thickness in a range of from 6 micron to 100 micron, including in a range of from 6 micron to 50 micron, or 10 micron to 40 micron.

In some embodiments, the sealing layer has a thickness of less than or equal to 120 micron, including less than or equal to 110 micron, less than or equal to 100 micron, less than or equal to 90 micron, less than or equal to 80 micron, less than or equal to 70 micron, less than or equal to 60 micron, less than or equal to 50 micron, less than or equal to 40 micron, less than or equal to 30 micron, less than or equal to 20 micron, less than or equal to 10 micron, or less than or equal to 5 micron.

In some embodiments, the inorganic coating layer comprises a thickness in the range of from 0.005 micron to 0.1 micron.

In some embodiments, the adhesive layer has a thickness in a range of from 0.5 micron to 10 micron. In some embodiments, the adhesive layer has a thickness in a range of from 2 micron to 4 micron.

Some embodiments of the disclosure are directed to hermetically sealed packages (e.g., thermoformed trays or cups with lids and retort pouches) formed from the multilayer packaging films. In some embodiments, the package further comprising at least one lap seal, the at least one lap seal bonding the first base layer of the multilayer packaging film to the sealing layer.

Further embodiments are directed to methods of producing multilayer packaging films. The methods of producing multilayer packaging films may include any suitable process known to the skilled artisan that does not vary the shrinkage values of the respective layers as described herein. In some embodiments, methods of producing multilayer packaging films include one or more of extrusion lamination, lacquer lamination or hot calendaring.

### BRIEF DESCRIPTION OF THE DRAWINGS

The disclosure may be more completely understood in consideration of the following detailed description of various embodiments of the disclosure in connection with the accompanying drawings, in which:

FIGS. 1, 2, 3, 4, and 5 are cross-sectional views of different embodiments of a multilayer packaging film; and

FIGS. 6 and 7 are perspective views of embodiments of hermetically sealed packages comprising a multilayer packaging film.

The drawings show some but not all embodiments. The elements depicted in the drawings are illustrative and not necessarily to scale, and the same (or similar) reference numbers denote the same (or similar) features throughout the drawings.

### DETAILED DESCRIPTION

It is believed that the packaging industry is moving toward more sustainable options, including streamlining of the materials used into narrow categories. For example, one option is to design packaging structures with high polyolefin content in order to categorize the films as recyclable. Elimination of non-olefinic polymers from the packaging structures often presents deficiencies in the overall performance of the packaging structure. In the case of packaging intended for heat treatment applications such as retort or pasteurization, polyolefin polymers are more sensitive to the application temperatures. Specifically, at high temperatures, polyolefin materials can shrink more than other polymeric materials and may become unsuitable as a structural component for an inorganic coating layer, as the polyolefins will be close to their melting point under retort or even pasteurization conditions compared to the more traditional, non-recyclable oPET films used to support barrier oxide coatings in retortable applications. The introduction of a selection of materials as described herein into the packaging film can reduce the negative effects of utilizing a more recyclable set of polymer materials. As a result, the barrier packaging films described herein are more easily recyclable due to the high polyolefin content yet retain the high performance attributes such as oxygen and moisture barrier.

As used herein, layers or films that are “in direct contact with” or “are directly adjacent to” each other have no intervening material between them.

“Inorganic Coating Layer” as used herein refers to a layer that comprises a metal layer or an oxide coating layer. The inorganic coating layer may act as a barrier layer. The inorganic coating layer may be vacuum deposited (i.e., vacuum coated, vapor coated, vacuum metalized) directly on the surface of the first base layer or the second base layer. Alternatively, the inorganic coating layer may be deposited by wet chemistry methods, such as solution coating, or applied through reactive coating techniques such as chemical vapor deposition.

As used herein, the term “polyolefin” generally includes polypropylene and polyethylene polymers. Alternatively, the term “polyolefin” includes a polybutene film. A polyolefin film may, for example, include an acid-modified polyolefin film obtained by graft-modifying a polyolefin polymer with an unsaturated carboxylic acid, an unsaturated carboxylic acid anhydride, an unsaturated carboxylic acid ester, or the like. Various pretreatment processes may be performed on the polyolefin films. The pretreatment processes may include any suitable process known to the skilled artisan that does not impair barrier performance. The pretreatment processes include, but are not limited to, a corona treatment, a plasma treatment, or flame treatment, or other similar processes. The polyolefin films may include an adhesive enhancement layer.

As described herein, one or more of the polyolefin films of the multilayer packaging film may be oriented. Orientation may be the result of monoaxially oriented (machine direction or transverse direction), or biaxially oriented (machine direction and transverse direction) stretching of the film, increasing the machine direction and/or transverse direction dimension and subsequently decreasing the thickness of the material. Biaxial orientation may be imparted to the film simultaneously or successively. In some embodiments, the film stretched in either or both directions at a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength and barrier. Orientation is typically accomplished by a double-or triple-bubble process, by a tenter-frame process or an MDO process using heated rolls. A typical blown film process does impart some stretching of the film, but not enough to be considered oriented as described herein. An oriented film may be heat set (i.e., annealed) after orientation, such that the film is relatively dimensionally stable (i.e., less than 10% free shrink) under elevated temperature conditions that might be experienced during conversion of the retort film laminate (i.e., printing or laminating) or during the use of the laminate (i.e., heat sealing or retort sterilization). As used herein, the terms “unoriented” and “non-oriented” refer to a monolayer or multilayer film, sheet or web that is substantially free of post-extrusion orientation.

As used throughout this application, the term “copolymer” refers to a polymer product obtained by the polymerization reaction or copolymerization of at least two monomer species. The term “copolymer” is also inclusive of the polymerization reaction of three, four or more monomer species having reaction products referred to as terpolymers, quaterpolymers, etc.

As used throughout this application, the term “polypropylene” or “PP” refers to, unless indicated otherwise, propylene homopolymers or copolymers. Such copolymers of propylene include copolymers of propylene with at least one alpha-olefin and copolymers of propylene with other units or groups. The term “polypropylene” or “PP” is used without regard to the presence or absence of substituent branch groups or other modifiers. Polypropylene includes, but is not limited to, homopolymer polypropylene, polypropylene impact copolymer, polypropylene random copolymer, propylene-ethylene copolymers, ethylene-propylene copolymers, maleic anhydride grafted polypropylenes and blends of such. Various polypropylene polymers may be recycled as reclaimed polypropylene or reclaimed polyolefin.

As used throughout this application, the term “polyethylene” or “PE” refers to, unless indicated otherwise, ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. Polyethylene includes, but is not limited to, medium density polyethylene, high density polyethylene, low density polyethylene, linear low-density polyethylene, ultra-low density polyethylene, ethylene alpha-olefin copolymer, ethylene vinyl acetate, ethylene acid copolymers, ethylene acrylate copolymers, neutralized ethylene copolymers such as ionomer, maleic anhydride grafted polyethylene and blends of such. Various polyethylene polymers may be recycled as reclaimed polyethylene or reclaimed polyolefin.

As used throughout this application, the term “polyester” or “PET” refers to a homopolymer or copolymer having an ester linkage between monomer units. The ester linkage may be represented by the general formula [O—R—OC(O)—R′—C(O)]ₙ where R and R′ are the same or different alkyl (or aryl) group and may generally be formed from the polymerization of dicarboxylic acid and diol monomers.

As used herein, the term “polyamide” refers to a high molecular weight polymer having amide linkages (—CONH—) n which occur along the molecular chain and includes “nylon” resins which are well known polymers having a multitude of uses including utility as packaging films. Examples of nylon polymeric resins for use in food packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 61/6T. Examples of polyamides include nylon homopolymers and copolymers such as nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof. Polyamide is used in films for food packaging and other applications because of its unique physical and chemical properties. Polyamide is selected as a material to improve temperature resistance, abrasion resistance, puncture strength and/or barrier of films. Properties of polyamide-containing films can be modified by selection of a wide variety of variables including copolymer selection, and converting methods (e.g., coextrusion, orientation, lamination, and coating).

As used herein, “polyurethane” is generally referencing polymers having organic units joined by urethane links (—NH—(C═O)—O—).

As used herein, “polylactic acid” is a polymer made from lactic acid and having a backbone of [—C(CH₃)HC(═O)O—]ₙ.

As used throughout this application, the term “vinyl alcohol copolymer” refers to film forming copolymers of vinyl alcohol (CH₂CHOH). Examples include, but are not limited to, ethylene vinyl alcohol copolymer (EVOH), butenediol vinyl alcohol copolymer (BVOH), and polyvinyl alcohol (PVOH).

As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

The term “layer”, as used herein, refers to a building block of a film that is a structure of a single material type or a homogeneous blend of materials. A layer may be a single polymer, a blend of materials within a single polymer type or a blend of various polymers, may contain metallic materials and may have additives. Layers may be continuous with the film or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major surfaces. In other words, one major surface of an exterior layer is exposed. An interior layer is one that is connected to another layer at both major surfaces. In other words, an interior layer is between two other layers. A layer may have sub-layers.

Similarly, the term “film”, as used herein, refers to a web built of layers and/or films, all of which are directly adjacent to and connected to each other. A film can be described as having a thickness that is insignificant as compared to the length and width of the film. A film has two major surfaces, the area of which are defined by the length and width of the film.

As used herein, the term “exterior” is used to describe a film or layer that is located on one of the major surfaces of the film in which it is comprised. As used herein, the term “interior” is used to describe a film or layer that is not located on the surface of the film in which it is comprised. An interior film or layer is adjacent to another film or layer on both sides.

As used herein, “barrier” or “barrier film” or “barrier layer” or “barrier material” refers to providing for reduced transmission to gases such as oxygen (i.e., containing an oxygen barrier material). The barrier material may provide reduced transmission to moisture (i.e., containing a moisture barrier material). The barrier characteristic may be provided by one or more barrier materials, or a blend of multiple barrier materials. The inorganic coating layer may act as a barrier layer. The barrier layer may provide the specific barrier required to preserve the product within a package throughout an extended shelf-life which may be several months or even more than one year.

The barrier may reduce the influx of oxygen through the barrier packaging film during the shelf-life of a packaged product (i.e., while the package is hermetically sealed). The oxygen transmission rate (OTR) of the multilayer packaging film is an indication of the barrier provided and can be measured according to ASTM F1927 using conditions of 1 atmosphere, 23° C. and 50% RH.

As used herein, a “multilayer packaging film” or “hermetically sealed package” or “retort stable package” is a film structure, or package made from the film structure, that maintains a high oxygen or moisture barrier level with little degradation after exposure to, at, or above the heat treatment temperature. The packages may be filled with product, sealed, and remain hermetically sealed, thus maintaining excellent barrier properties.

As used herein, “free shrink” or “shrinkage value” is an unrestrained linear shrinkage that a film or layer undergoes due to exposure to elevated temperature. The shrink is irreversible and relatively rapid (i.e., evident within seconds or minutes). Shrinkage value is expressed as a percentage of the original dimension, (i.e., 100×(pre-shrink dimension−post-shrink dimension)/(pre-shrink dimension)). Free shrink can be measured using any suitable method that is capable of measuring shrinkage value differences of at least 0.2%. Free shrink can be measured using ASTM D2732-03. As described in ASTM D2732-03, free shrink is a value obtained by measuring unrestrained (i.e., free) shrink of a 10 cm square sample immersed in water at 90° C. for five seconds. ASTM D2732-03 includes at least the following steps:
1. Stamp and cut out the stamped section of film.
2. Place the specimen in a free shrink holder such that it is free from contact with the edges of the holder.
   i. A minimum of two specimens is necessary for each temperature.
3. Observe and record the temperature of the bath before immersion of each specimen.
4. Immerse the specimen in the bath for 10 seconds or a time determined to be sufficient for the material to come to thermal equilibrium and undergo maximum shrinkage.
5. Remove the specimen from the bath and quickly immerse in a liquid medium at room temperature preferably miscible with the bath medium.
6. After 5 seconds remove the specimen from the cooling medium and measure and record the linear dimensions of the specimen in both the machine (longitudinal) and transverse directions.
7. Determine the percent free shrinkage for each direction as follows:

$$Unrestrained linear shrinkage , \% = [ ( {L}_{0} - {L}_{f} ) / {L}_{0} ] \times 100 \qquad ( 1 )$$

where:
L₀=initial length of side (100 mm), and
L_{f}=length of side after shrinking.
8. The report shall include the following:
   i. Average percent linear free shrinkage in both directions, machine (longitudinal) and transverse,
   ii. Bath temperature,
   iii. Complete sample identification, and
   iv. Number of specimens tested.
      ASTM D2732-03, Standard Test Method for Unrestrained Linear Thermal Shrinkage of Plastic Film and Sheeting, available at https://petro-pack.com/wp-content/uploads/D-2732-Shrinkage.pdf

Without intending to be bound by any particular theory, it is thought that a person of ordinary skill in the art would measure free shrink using the protocol in ASTM D2732-03.

Alternatively, free shrink can be measured by using the test method described in ASTM D2732-03 with a modification of using hot air as the heating source instead of a hot fluid bath. If using the hot air method, the unrestrained sample is placed in an oven set at the specified temperature for a time span of at least 1 minute, giving the oven interior and sample ample time to come to thermal equilibrium.

Alternatively, shrinkage value is calculated after measuring linear dimension in a machine direction (MD) before and after shrinking, according to Formula 1:

$$\frac{MD ( before heating ) - MD ( after heating )}{MD ( before heating )} ⋆ 100 \qquad ( 1 )$$

Shrinkage value may be measured after heating at 120° C. for 15 minutes. Alternatively, shrinkage value may be measured after heating at 127° C. for 50 minutes.

The multilayer packaging films described herein may be useful as retort or pasteurization packaging films. As used herein, a “retort packaging film” or “retort packaging” is a film, or package made from the film, that can be filled with product, sealed, and remain hermetically sealed after being exposed to a typical retort sterilization process. Typical retort sterilization is a batch process that uses temperatures in a range of from about 100° C. to about 150° C., over-pressure up to about 70 psi (483 kPa), and may have a duration from a few minutes up to several hours. Common retort processes used for products packaged in flexible films include steam or water immersion. Food or other products packaged in retort packaging film and retort sterilized can be stored at ambient conditions for extended periods of time (i.e., are shelf-stable), retaining sterility. Because the retort process degrades the films, or packages made from the films, very specialized flexible packaging films have been designed to survive the retort process.

As used herein, the term “adhesive layer” refers to a layer which has a primary function of bonding two adjacent layers together. The adhesive layers may be positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material.

The adhesive layer may be deposited on the polyolefin film of one or more of the first base layer or the second base layer by any suitable method known to the skilled artisan. In some embodiments, depositing the adhesive layer includes, but is not limited to, an immersion method (dipping method) and methods that use a sprayer, a coater, a printer, a brush, or the like. In addition, examples of the types of coaters and printers used in these methods, and the coating methods thereof may include a gravure coater, a reverse-roll coater, a micro gravure coater, a combined chamber and doctor coater, an air-knife coater, a dip coater, a bar coater, a comma coater, and a die coater for a direct gravure method, a reverse gravure method, a kiss reverse gravure method, an offset gravure method, and the like.

The adhesive layer may be dried by any suitable method known to the skilled artisan. The method of drying the adhesive layer includes, but is not limited to, a method of drying naturally, a method of drying in an oven set at a predetermined temperature, and methods using drying machines attached to the coaters such as an arch dryer, a floating dryer, a drum dryer and an infrared ray dryer. The drying conditions may be selected based on the drying method. For example, in the method of drying in an oven, the adhesive layer may be dried at a temperature in a range of from 60° C. to 100° C. for about 1 second to 2 minutes.

As used herein, the term “sealing layer” refers to a layer of a film, sheet, etc., involved in the sealing of the film, sheet, etc., to itself and/or to another layer of the same or another film, sheet, etc. As used herein, the terms “heat seal”, “heat sealed”, “heat sealing”, “heat sealable”, and the like, refer to both a film layer which is heat sealable to itself or other thermoplastic film layer, and the formation of a fusion bond between two polymer surfaces by conventional indirect heating means. It will be appreciated that conventional indirect heating generates sufficient heat on at least one film contact surface for conduction to the contiguous film contact surface such that the formation of a bond interface therebetween is achieved without loss of the film integrity.

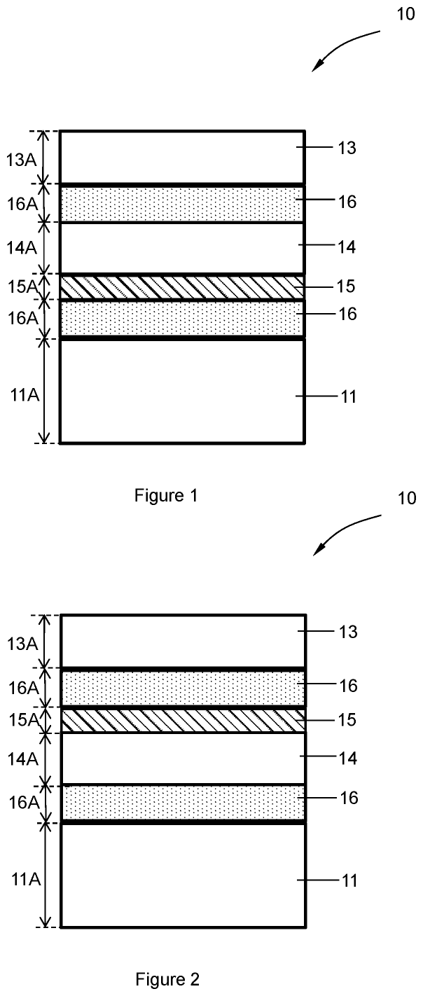

Embodiments of a multilayer packaging film structure are illustrated in FIGS. 1-7. While embodiments of the multilayer packaging film structure may be described with reference to FIGS. 1-7, one or more aspects of the multilayer packaging film structure may have the same properties as its corresponding feature in a different figure. For example, the multilayer packaging film structure 10 may have the same properties as the multilayer packaging film structure 110, 210 of hermetically sealed packages (e.g., thermoformed trays or cups 100 and retort pouches 200). Without being limited to any particular embodiment, the method 500 may be used to form embodiments of the multilayer packaging film structure illustrated in any of FIGS. 1-7.

FIG. 1 illustrates a cross-sectional view of an embodiment of a multilayer packaging film 10. The multilayer packaging film 10 includes a first base layer 13 on a second base layer 14. The second base layer 14 has an inorganic coating layer 15 on one side. The multilayer packaging film 10 includes an adhesive layer 16 between and in direct contact with the first base layer 13 and the second base layer 14, an adhesive layer 16 that is between and in direct contact with the inorganic coating layer 15 that is on the second base layer 14 and a sealing layer 11. In FIG. 1, the first base layer 13 forms an exterior layer of the multilayer packaging film 10 and the sealing layer 11 forms the opposing exterior layer of the multilayer packaging film 10.

FIG. 2 illustrates a cross-sectional view of an embodiment of a multilayer packaging film 10. The multilayer packaging film 10 includes a first base layer 13 on a second base layer 14. The second base layer 14 has an inorganic coating layer 15 on one side. FIG. 2 illustrates the inorganic coating layer 15 as being on the opposite side of the second base layer 14 as the inorganic coating layer 15 on the second base layer 14 shown in FIG. 1. The multilayer packaging film 10 includes an adhesive layer 16 between and in direct contact with the first base layer 13 and the inorganic coating layer 15 that is on the second base layer 14, and an adhesive layer 16 between and in direct contact with the second base layer 14 and a sealing layer 11. In FIG. 2, the first base layer 13 forms an exterior layer of the multilayer packaging film 10 and the sealing layer 11 forms the opposing exterior layer of the multilayer packaging film 10.

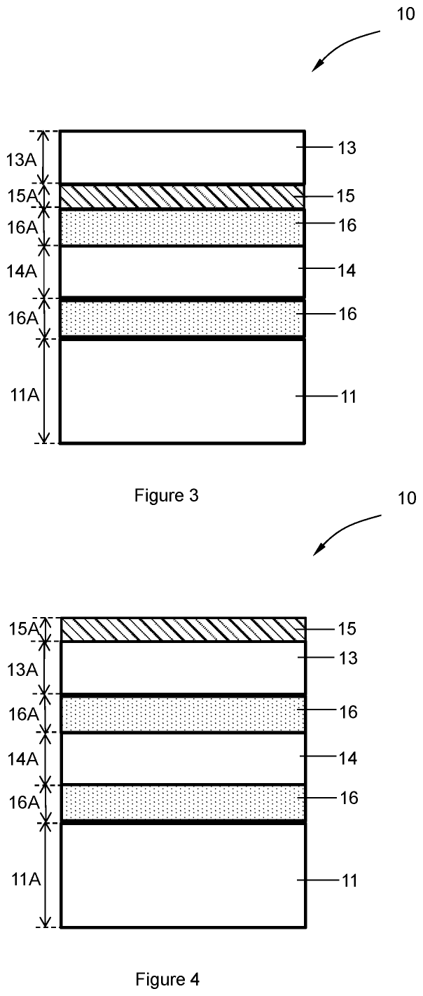

FIG. 3 illustrates a cross-sectional view of an embodiment of a multilayer packaging film 10. The multilayer packaging film 10 includes a first base layer 13 on a second base layer 14. The first base layer 13 has an inorganic coating layer 15 on one side. The multilayer packaging film 10 includes an adhesive layer 16 between and in direct contact with the first base layer 13 and the second base layer 14, and an adhesive layer 16 between and in direct contact with the second base layer 14 and a sealing layer 11. In FIG. 3, the first base layer 13 forms an exterior layer of the multilayer packaging film 10 and the sealing layer 11 forms the opposing exterior layer of the multilayer packaging film 10.

FIG. 4 illustrates a cross-sectional view of an embodiment of a multilayer packaging film 10. The multilayer packaging film 10 includes a first base layer 13 on a second base layer 14. The first base layer 13 has an inorganic coating layer 15 on one side. FIG. 4 illustrates the inorganic coating layer 15 as being on the opposite side of the first base layer 13 as the inorganic coating layer 15 on the first base layer 13 shown in FIG. 3. The multilayer packaging film 10 includes an adhesive layer 16 between and in direct contact with the first base layer 13 and the second base layer 14, and an adhesive layer 16 between and in direct contact with the second base layer 14 and a sealing layer 11. In FIG. 3, the inorganic coating layer 15 that is on the first base layer 13 forms an exterior layer of the multilayer packaging film 10 and the sealing layer 11 forms the opposing exterior layer of the multilayer packaging film 10.

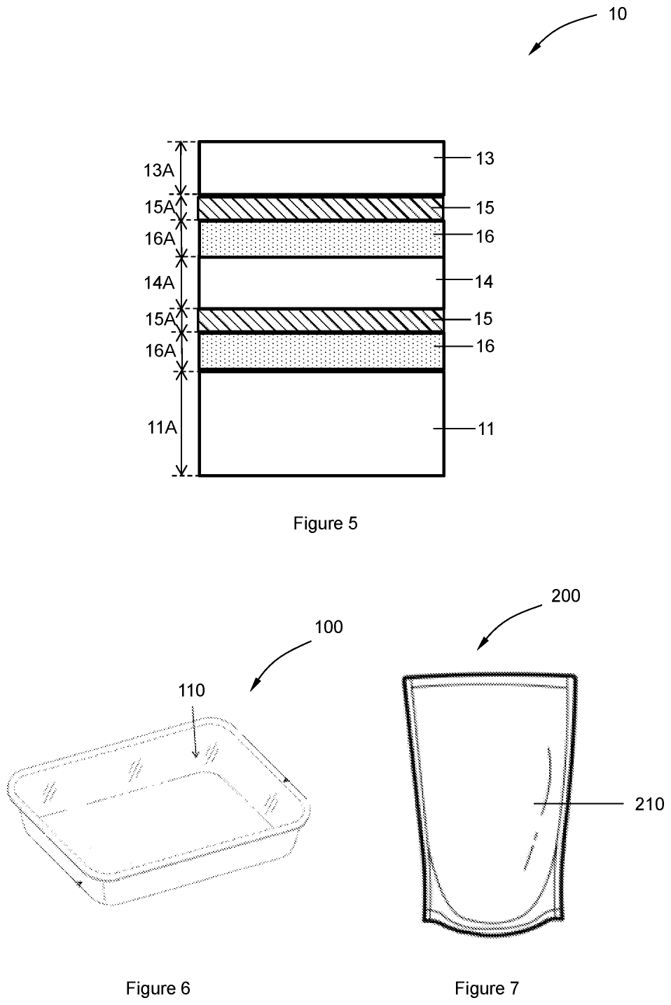

FIG. 5 illustrates a cross-sectional view of an alternative embodiment of a multilayer packaging film 10. In the alternative embodiment shown in FIG. 5, the multilayer packaging film 10 includes a first base layer 13 and a second base layer 14, each having an inorganic coating layer 15 thereon. In FIG. 5, an inorganic coating layer 15 is between and indirect contact with the first base layer 13 and an adhesive layer 16, and an inorganic coating layer 15 is between and indirect contact with the second base layer 14 and an adhesive layer 16. The sealing layer 11 is directly adjacent to the adhesive layer 16 that is on the inorganic coating layer 15 on the second base layer 14. In FIG. 5, the first base layer 13 forms an exterior layer of the multilayer packaging film 10 and the sealing layer 11 forms the opposing exterior layer of the multilayer packaging film 10. As illustrated in FIGS. 1-4, the inorganic coating layer 15 may be positioned on one or more sides of the first base layer 13 and the second base layer 14.

The first base layer 13 and the second base layer 14 have a thickness 13A, 14A measured in a z-direction. In some embodiments, each of the first base layer 13 and the second base layer 14 have a thickness 13A, 14A in a range of from 6 micron to 100 micron, including in a range of from 6 micron to 50 micron, or 10 micron to 40 micron.

The adhesive layer 16 has a thickness 16A measured in a z-direction. In some embodiments, the adhesive layer 16 has a thickness 16A in a range of from 0.5 micron to 10 micron.

The inorganic coating layer 15 has a thickness 15A measured in the z-direction. The inorganic coating layer 15 has a thickness 15A in a range of from 0.005 micron to 0.1 micron, in a range of from 0.005 micron to 0.06 micron, in a range of from 0.01 micron to 0.1 micron or in a range of from 0.01 micron to 0.06 micron. An inorganic coating layer having thickness greater than these ranges may result in a layer that is not able to flex to accommodate the surface area change without cracking or otherwise failing.

The sealing layer 11 has a thickness 11A measured in a z-direction. In some embodiments, the sealing layer 11 has a thickness 11A of less than or equal to 120 micron, including less than or equal to 110 micron, less than or equal to 100 micron, less than or equal to 90 micron, less than or equal to 80 micron, less than or equal to 70 micron, less than or equal to 60 micron, including less than or equal to 50 micron, less than or equal to 40 micron, less than or equal to 30 micron, less than or equal to 20 micron, less than or equal to 10 micron, less than or equal to 5 micron, or less than or equal to 1 micron.

The free shrink of the first base layer at 95° C., or another elevated processing temperature which the multilayer packaging film is exposed, causes a decrease in the surface area of the first base layer. It is believed that any layer adjacent to or near the shrinking first base layer experiences a shrink force in the x-y direction, due to the reduction of surface area. The free shrink of each respective layer/film may be measured alone. Alternatively, the free shrink of each respective layer/film may be measured on a combination of one or more layers/films together (including any intervening layers that may be present).

The first base layer and/or the second base layer may be a film and the film may be produced by any known process, for example blown film or cast film. The first base layer and/or the second base layer may be a monoaxially oriented polypropylene film (MDOPP), a biaxially oriented polypropylene film (BOPP), a monoaxially oriented polyethylene film (MDOPE), or a biaxially oriented polyethylene film (BOPE). The first base layer and/or the second base layer may be produced using specific polymers and may be oriented using specific conditions which optimize the heat resistance of the film.

In some embodiments, the polyolefin film of each of the first base layer and the second base layer is an oriented polyethylene (OPE) film or an oriented polypropylene (OPP) film. In some embodiments, one or more of the oriented polyethylene (OPE) film or the oriented polypropylene (OPP) film is formed by one or more of a sequential stretching process or a simultaneous stretching process. In some embodiments, the simultaneous stretching process is one or more of a linear motor simultaneous stretching process, a double bubble process, or a triple bubble process.

In one or more embodiments, the oriented polypropylene (OPP) film is a coextruded OPP film. In one or more embodiments, the oriented polypropylene (OPP) film is a coextruded OPP film having a first side that is treated and a second side that is treated.

In some embodiments, the polyolefin film comprises a biaxially oriented polypropylene (BOPP) film. In one or more embodiments, the biaxially oriented polypropylene (BOPP) film is formed by a linear motor simultaneous stretching process, the biaxially oriented polypropylene (BOPP) film having a first side that is treated and not sealable and a second side that is sealable. In one or more embodiments, the biaxially oriented polypropylene (BOPP) film is formed by a triple bubble process, the biaxially oriented polypropylene (BOPP) film having a first side that is treated and not sealable and a second side that is sealable.

The inorganic coating layer provides a significant contribution to the oxygen barrier (OTR reduction) to the multilayer packaging film.

In one or more embodiments, the inorganic coating layer of the multilayer packaging film comprises one or more of an oxide, a metal oxide, a nitride, or a metal nitride. In some embodiments, the inorganic coating layer comprises one or more of aluminum (Al) or silicon (Si). In some embodiments, the inorganic coating layer comprises an alloy of aluminum (Al) and any suitable metal oxide known to the skilled artisan. In some embodiments, the inorganic coating layer comprises an alloy of silicon (Si) and any suitable metal oxide known to the skilled artisan.

In some embodiments, the inorganic coating layer comprises one or more of a transparent oxide coating such as aluminum oxide (AlOx) or silicon oxide (SiOx). The inorganic coating layer may comprise any transparent ceramic known to the skilled artisan, including but not limited to, an oxide, a nitride, or a carbide.

In some embodiments, the inorganic coating layer comprises silicon oxide (SiOx). In embodiments where the inorganic coating layer comprises silicon oxide (SiOx), a ratio of oxygen (O) atomic weight to silicon (Si) atomic weight is measured. In embodiments where the inorganic coating layer comprises silicon oxide (SiOx), the ratio of oxygen (O) atomic weight to silicon (Si) atomic weight is in a range of from 1 to 3. In embodiments where the inorganic coating layer comprises silicon oxide (SiOx), the ratio of oxygen (O) atomic weight to silicon (Si) atomic weight is measured using any suitable analytical technique known to the skilled artisan, such as, for example, x-ray photoelectron spectroscopy.

In alternative embodiments, the inorganic coating layer comprises one or more of magnesium oxide (MgOx) or tin oxide (SnOx).

The inorganic coating may be applied by any suitable process known to the skilled artisan. In some embodiments, the inorganic coating is applied by a vacuum deposition process, such as chemical vapor deposition or physical vapor deposition. Alternatively, the inorganic coating layer may be applied using a wet chemistry technique.

The sealing layer may comprise polyolefin materials. In some embodiments, the sealing layer comprises polypropylene. In some embodiments, the sealing layer comprises one or more of a polypropylene copolymer, a polypropylene terpolymer, polybutylene, polyethylene, a polyethylene copolymer, a polyethylene terpolymer, LLDPE, mLLDPE, MDPE, or HDPE. The sealing layer may comprise a formula of polymers designed to reduce the heat seal initiation temperature to compliment the heat resistance of the opposite exterior layer. Even though the sealing layer may have a rather low temperature softening point, the sealing layer may have enough integrity to survive the high temperatures of a high temperature sterilization process along with other abuses a package may endure during distribution and use.

In some embodiments, the sealing layer of the multilayer packaging film has a composition that will allow the formation of a heat seal, thus forming a hermetic package. As used herein, the term “heat seal” or “heat sealed” refers to two or more surfaces that have been bonded together by application of both heat and pressure for a short period of time, or by way of an ultrasonic energy sealing process. Heat sealing and ultrasonic sealing are well-known and commonly used processes for creating packages and are familiar to those skilled in the art.

The sealing layer is necessarily on the surface of the multilayer packaging film in order to facilitate the function of sealing. During use of the multilayer packaging film in a package, the sealing layer may be heat sealed to itself or another packaging component. During heat sealing, the sealing layer softens, allowing formation of a heat seal bond, at a sealing temperature that is lower than the temperature resistance of the opposite exterior layer of the multilayer packaging film. The sealing layer softens at a sealing temperature that is lower than the temperature resistance of the opposite exterior layer. The sealing layer softens and forms a heat seal at sealing conditions (time, temperature and pressure) that do not cause excessive shrinking or marring on the exterior surface of the multilayer packaging film.

The multilayer packaging film is targeted to contain high amounts of polyolefin, specifically polypropylene or polyethylene, such that the multilayer packaging film may be acceptable for a recycling process. Polyolefins have relatively low heat resistance as compared to materials traditionally used for packaging films (i.e., polyester, aluminum foil, polyamide). As a result of the lower heat resistance, the packages will be formed using a heat-sealing process with lower temperatures to avoid any shrinking or burn through. The challenge met by the multilayer packaging films disclosed herein is to incorporate a sealing layer that has a low heat-seal initiation temperature (HSIT) and a high seal strength and seal toughness to survive both retort or pasteurization processing and normal distribution and handling (i.e., drop strength and burst strength). In some embodiments, the sealing layer also contains materials that are approved for food contact during retort conditions, as dictated by governmental agencies for food safety.

The sealing layer may contain a material that has a low heat seal initiation temperature (HSIT). In some embodiments of the retort packaging film, the sealing layer contains a polypropylene copolymer having a melt temperature equal to or less than 135° C.

The sealing layer may be a mono-layer film, such as a non-oriented cast polypropylene film. The sealing layer may be an exterior layer of a multilayer coextruded film, such as a blown film. The entire multilayer coextruded film is attached to the second base layer, the sealing layer being positioned opposite of the second base layer, thus exposed.

The multilayer packaging film may have an overall thickness from about 30 micron to about 180 micron.

While the structure of the multilayer packaging film and any packages made therefrom contain several different elements (sealing layer, first base layer, second base layer, inorganic coating layer, adhesive, etc.) the total composition of the film or package should have high levels of a single material type (polyolefin or specifically, polypropylene or polyethylene) to facilitate recycling. As used herein, the term “total composition” is used to describe the entire film structure or package. Any materials, layers or components that are connected to one another in any way are part of the total composition of that article. The multilayer packaging films may have high levels of polyolefin-based polymers. The multilayer packaging films may have high levels of polypropylene-based polymers. The multilayer packaging films may have high levels of polyethylene-based polymers. The multilayer packaging films described herein, and any packages made therefrom, may be recyclable in a polypropylene recycling process when the article contains high amounts of polypropylene-based polymers. The multilayer packaging films described herein, and any packages made therefrom, may be recyclable in a polyethylene recycling process when the article contains high amounts of polyethylene-based polymers. A mixed polyolefin recycling process can also accept relatively high levels of polyolefins present in the multilayer packaging films described herein, and any packages made therefrom.

The multilayer packaging films described herein may have a total composition that contains at least 80%, at least 85%, at least 90%, or at least 95% polyolefin-based polymers by weight, promoting recyclability of the film and/or package in which it is used. Materials that are not polyolefin-based polymers are minimized. For example, the inorganic coating layer of the multilayer packaging film is a material that is not a polyolefin-based material and thus is provided in as thin of a layer as possible to function properly as a barrier. The multilayer packaging film may also have other non-polyolefin materials, such as those located in the adhesive layer.

In specific embodiments of the multilayer packaging films, the film has a total composition that contains at least 80%, at least 85%, at least 90%, or at least 95% polypropylene-based polymers by weight. In specific embodiments of the multilayer packaging films, the film has a total composition that contains at least 80%, at least 85%, at least 90%, or at least 95% polyethylene-based polymers by weight.

Using the combination of film structure design elements as described herein, a more heat durable multilayer packaging film can be achieved. The films may be suitable to be recycled in a polyolefin-based recycling process because of the high polyolefin content. The films may have low levels (i.e., ≤5%, by weight) of, or may be essentially free from, materials such as polyester, polyamide, chlorine containing polymers and aluminum foil. As used herein, the term “essentially free of” means that that there is less than about 5%, including less than about 4%, less than about 3%, less than about 2%, less than about 1%, and less than about 0.5% from, materials such as polyester, polyamide, chlorine containing polymers and aluminum foil on an atomic basis.

The films may contain non-polyolefin-based polymers such as those used in adhesive layers, but the amount of non-polyolefin-based polymers is minimized and generally comprises less than or equal to 10% of the overall composition or less than 5% of the overall composition, by weight. The films may contain non-polymeric materials such as barrier materials, but the amount of non-polymeric materials is minimized and generally comprises less than 10% of the overall composition or less than 5% of the overall composition, by weight.

As previously described herein, an increase in environmental temperature may cause the first base layer, the second base layer and/or the sealing layer to shrink slightly in one or more directions. As the temperature rises, the polymeric material softens, releasing tension that may have been embedded in the layer upon production. The tension release may result in a movement and rearrangement of the polymer chains and an ultimate change (increase or decrease) in the dimensions of the layer. A common result of increasing temperature on the first base layer, the second base layer and/or the sealing layer is a slight reduction (i.e., shrink) of the first base layer, the second base layer and/or the sealing layer in at least one direction parallel with the x-y plane of the layer.

Upon shrinking of the first base layer, the second base layer and/or the sealing layer, a compressive force is applied to the other layers within the multilayer packaging film with the largest force being applied to the adjacent layers. The other layers may also have a shrinking tendency at the elevated temperature, and it is likely that the free shrink of each layer is slightly different. The greatest difference in free shrink is likely found when comparing any polymeric layer to the inorganic coating layer of the multilayer packaging film. Most inorganic coatings experience no shrink at the temperatures at which the first base layer, the second base layer and/or the sealing layer will shrink (e.g., 95° C. or some other temperature). Additionally, inorganic coatings also have very high modulus (high stiffness) at these elevated temperatures.

In some embodiments, before being exposed to elevated heat conditions, the multilayer packaging film may have an average oxygen transmission rate (OTR) value that is less than or equal to 2 cm³/m²/day, less than or equal to 1 cm³/m²/day, less than or equal to 0.5 cm³/m²/day, or less than or equal to 0.1 cm³/m²/day (measured according to ASTM F1927 using conditions of 1 atmosphere, 23° C. and 50% RH).

In some embodiments, after being exposed to a representative retort sterilization process, the barrier packaging film has an average OTR value that is less than or equal to 2.5 cm³/m²/day, less than or equal to 2 cm³/m²/day, less than or equal to 1 cm³/m²/day, less than or equal to 0.5 cm³/m²/day, or less than or equal to 0.1 cm³/m²/day. The average OTR value may be near, at, or below the minimum detection level of a testing device. The representative retort sterilization process is completed by cutting a DIN A4 sized portion of the packaging film and exposing it to a steam sterilization process for 60 minutes at 128° C. and overpressure of 2.5 bar, followed by water shower cooling.

The multilayer packaging film 10, 110, 210 can be formed into packages, with or without other packaging components. For example, the multilayer packaging film 210 can be formed into a flexible stand-up pouch 200 as shown in FIG. 7. In another embodiment of a hermetically sealed package 100, the multilayer packaging film 110 may be a lid material sealed to a thermoformed tray or cup, as shown in FIG. 6.

The multilayer packaging films disclosed herein maintain excellent barrier properties and visual appearance, even after the film has been formed into a package, filled, hermetically sealed and undergone the retort sterilization process.

The disclosure is now described with reference to the following examples.

### EXAMPLES AND DATA

Several film structures were produced as summarized in Table 1 below.

TABLE 1
Identification and Properties of Base Layers and Free
Shrink Value of Base Layer in Machine Direction (MD)

| | | | Free Shrink in |
|---|---|---|---|
| | | Film | Machine |
| | | Thickness | Direction (MD) |
| Identification | Film Material | (micron) | (%) |
| A | Non-sealable one side treated BOPP film | 25 | 2.5% |
| | produced in a simultaneous stretching | | |
| | process, known as Lisim ® process | | |
| B | Coextruded BOPP film one side corona | 20 | 5% |
| | treated made on a triple bubble line with | | |
| | higher shrinkage | | |
| C | Non-sealable coextruded OPP film, 2 side | 18 | 4% |
| | corona treated. | | |
| D | Coextruded OPP film - one side treated | 18 | 3.5% |
| | and not sealable, one side sealable | | |
| E | Non-sealable one side treated BOPP film | 25 | 3.2% |
| | produced in a simultaneous stretching | | |
| | process, known as Lisim ® process | | |
| F | BOPP film with increased thermal | 25 | 3.6% |
| | resistance and shrinkage properties | | |

Table 1 identifies and lists properties for each of the base layers A-F. Table 1 also lists the Free Shrink value of each of the base layers A-F measured in machine direction at 120° C.

TABLE 2
Comparative Shrink Value of First Base Layer to Second Base Layer and Average
Oxygen Transmission Data for Example and Comparative Example Structures

| | First | Second | Comparative Shrink Value of | OTR* - | OTR* - |
|---|---|---|---|---|---|
| | Base | Base | First Base Layer to Second | before | after |
| Identification | Layer | Layer | Base Layer | heating | heating |
| Comparative | A1 | D2 | Shrink Value of Second Base | 0.08 | 0.33 |
| Example | (Bare) | (Primed + | Layer > Shrink Value of First | | |
| | | SiOx) | Base Layer | | |
| Example 1 | F1 | A2 | Shrink Value of First Base | 0.01 | 1.25 |
| | (Bare) | (Primed + | Layer > Shrink Value of | | |
| | | SiOx) | Second Base Layer | | |
| Example 2 | E1 | A2 | Shrink Value of First Base | 0.03 | 1.3 |
| | (Bare) | (Primed + | Layer > Shrink Value of | | |
| | | SiOx) | Second Base Layer | | |
| Example 3 | A1 | A2 | Shrink Value of First Base | 0.02 | 1.24 |
| | (Bare) | (Primed + | Layer > Shrink Value of | | |
| | | SiOx) | Second Base Layer | | |
| Example 4 | C2 | A1 | Shrink Value of First Base | 0.11 | 0.61 |
| | (Primed + | (Bare) | Layer > Shrink Value of | | |
| | SiOx) | | Second Base Layer | | |
| Example 5 | B1 | D2 | Shrink Value of First Base | 0.09 | 0.87 |
| | (Bare) | (Primed + | Layer > Shrink Value of | | |
| | | SiOx) | Second Base Layer | | |
| Example 6 | D1 | C2 | Shrink Value of First Base | 0.1 | 1.87 |
| | (Bare) | (Primed + | Layer > Shrink Value of | | |
| | | SiOx) | Second Base Layer | | |
| Example 7 | A2 | B1 | Shrink Value of Second Base | 0.03 | 1.78 |
| | (Primed + | (Bare) | Layer = 8 | | |
| | SiOx) | | | | |
| Example 8 | C2 | B1 | Shrink Value of Second Base | 0.1 | 2.5 |
| | (Primed + | (Bare) | Layer = 8 | | |
| | SiOx) | | | | |

*OTR units are cm³/m²/day measured according to ASTM F1927 using conditions of a pressure of 1 atmosphere, a temperature of 23° C. and a elative humidity (RH) of 50%.

Table 2 lists the surface treatment for each of base layers A-F (e.g., “Bare” or “Primed+SiOx”). As a general convention, base layers A-F having a 1 (e.g., A1) are bare and base layers A-F having a 2 (e.g., A2) are primed and have a silicon oxide coating thereon.

Table 2 lists the OTR for the multilayer packaging film structure for each of A1-F2 before heating and after heating. The oxygen transmission rate (OTR) of the multilayer packaging film is an indication of the barrier provided and can be measured according to ASTM F1927 using conditions of a pressure of 1 atmosphere, a temperature of 23° C. and a relative humidity (RH) of 50%.

TABLE 3
Identification and Properties of Base Layers in Multilayer Packaging Films

| | First Base | Second Base | |
|---|---|---|---|
| Identification | Layer | Layer | Multilayer Packaging Film Structure |
| Comparative | A1 | D2 | First base layer//adhesive//second base |
| Example | (Bare) | (Primed + | layer with inorganic coating on either side// |
| | | SiOx) | adhesive//sealing layer (60 micron) |
| Example 1 | F1 | A2 | First base layer//adhesive//second base |
| | (Bare) | (Primed + | layer with inorganic coating on either side// |
| | | SiOx) | adhesive//sealing layer (60 micron) |
| Example 2 | E1 | A2 | First base layer//adhesive//second base |
| | (Bare) | (Primed + | layer with inorganic coating on either side// |
| | | SiOx) | adhesive//sealing layer (60 micron) |
| Example 3 | A1 | A2 | First base layer//adhesive//second base |
| | (Bare) | (Primer + | layer with inorganic coating on either side// |
| | | SiOx) | adhesive//sealing layer (60 micron) |
| Example 4 | C2 | A1 | First base layer with inorganic coating |
| | (Primer + | (Bare) | buried within the film structure//adhesive// |
| | SiOx) | | second base layer//adhesive//sealing |
| | | | layer (60 micron) |
| Example 5 | B1 | D2 | First base layer//adhesive//second base |
| | (Bare) | (Primer + | layer with inorganic coating on either side// |
| | | SiOx) | adhesive//sealing layer (60 micron) |
| Example 6 | D1 | C2 | First base layer//adhesive//second base |
| | (Bare) | (Primer + | layer with inorganic coating on either side// |
| | | SiOx) | adhesive//sealing layer (60 micron) |
| Example 7 | A2 | B1 | First base layer with inorganic coating |
| | (Primer + | (Bare) | buried within the film structure//adhesive// |
| | SiOx) | | second base layer//adhesive//sealing |
| | | | layer (60 micron) |
| Example 8 | C2 | B1 | First base layer with inorganic coating |
| | (Primer + | (Bare) | buried within the film structure//adhesive// |
| | SiOx) | | second base layer//adhesive//sealing |
| | | | layer (60 micron) |

In Table 3, the multilayer packaging film structure comprises base layers A-F identified above. The multilayer packaging film structures of Table 3 comprise a first base layer, a second base layer, one or more adhesive layers, one or more inorganic oxide coating layers, and a sealing layer. The Figures illustrates the multilayer packaging film structure having base layers A-F.

The multilayer packaging film structure for each of A-F was prepared by applying a water-based polyurethane (PU) dispersion (primer) to the surface of each of the first base layer and the second base layer to form a 1.7 micron primer coating after drying the dispersion. The inorganic coating layers on each of the first base layer and the second base layer, as applicable above, comprise a silicon oxide coating (SiOx) which was applied by vapor deposition to the surface of the primer. A 60 micron polypropylene sealing layer was then adhesively laminated to the silicon oxide coating.

### Embodiments

Embodiment 1: A multilayer packaging film comprising: a first base layer comprising a polyolefin film; a second base layer on the first base layer, the second base layer comprising a polyolefin film; and a sealing layer on the second base layer, the sealing layer comprising a polyolefin film, wherein one or more of the first base layer or the second base layer comprises an inorganic coating thereon, and wherein the second base layer has a shrinkage value that is greater than 5%.

Embodiment 2: The multilayer packaging film according to Embodiment 1, wherein the shrinkage value of the second base layer is greater than or equal to a shrinkage value of the first base layer.

Embodiment 3: The multilayer packaging film according to any previous embodiment, wherein the shrinkage value of the second base layer is greater than or equal to a shrinkage value of the sealing layer.

Embodiment 4: A multilayer packaging film comprising: a first base layer comprising a polyolefin film; a second base layer on the first base layer, the second base layer comprising a polyolefin film; and a sealing layer on the second base layer, the sealing layer comprising a polyolefin film, wherein one or more of the first base layer or the second base layer comprises an inorganic coating thereon, and a shrinkage value of the second base layer is less than a shrinkage value of the first base layer.

Embodiment 5: The multilayer packaging film according to Embodiment 4, wherein the second base layer has a shrinkage value that is less than or equal to 5%.

Embodiment 6: The multilayer packaging film according to any one of Embodiments 4 through 5, wherein the shrinkage value of the second base layer is greater than or equal to a shrinkage value of the sealing layer.

Embodiment 7: A multilayer packaging film comprising: a first base layer comprising a polyolefin film; a second base layer on the first base layer, the second base layer comprising a polyolefin film; and a sealing layer on the second base layer, the second base layer comprising a polyolefin film, wherein one or more of the first base layer or the second base layer comprises an inorganic coating thereon, wherein the second base layer has a shrinkage value that is greater than 5%, and the shrinkage value of the second base layer is less than a shrinkage value of the first base layer.

Embodiment 8: The multilayer packaging film according to Embodiment 8, wherein the shrinkage value of the second base layer is greater than or equal to a shrinkage value of the sealing layer.

Embodiment 9: The multilayer packaging film according to any previous embodiment, wherein the shrinkage value of the second base layer is less than or equal to 5%.

Embodiment 10: The multilayer packaging film according to any previous embodiment, wherein the difference in shrinkage value of the first base layer and the second base layer is greater than or equal to 0.3%.

Embodiment 11: The multilayer packaging film according to any previous embodiment, wherein the difference in shrinkage value of the second base layer and the sealing layer is greater than or equal to 0.5%.

Embodiment 12: The multilayer packaging film according to any previous embodiment, wherein the shrinkage value of the sealing layer is greater than or equal to 2%.

Embodiment 13: The multilayer packaging film according to any previous embodiment, wherein the shrinkage value of each of the first base layer, the second base layer, and the sealing layer is measured in a machine direction (MD) according to Formula 1:

$$\frac{MD ( before heating ) - MD ( after heating )}{MD ( before heating )} ⋆ 100 \qquad ( 1 )$$

Embodiment 14: The multilayer packaging film according to any previous embodiment, wherein the shrinkage value of each of the first base layer, the second base layer, and the sealing layer is measured using the method disclosed in ASTM D2732-03.

Embodiment 15: The multilayer packaging film according to any previous embodiment, wherein the shrinkage value of each of the first base layer, the second base layer, and the sealing layer is measured after heating at 120° C. for 15 minutes.

Embodiment 16: The multilayer packaging film according to any previous embodiment, wherein the shrinkage value of each of the first base layer, the second base layer, and the sealing layer is measured after heating at 127° C. for 50 minutes.

Embodiment 17: The multilayer packaging film according to any previous embodiment, wherein the polyolefin film of each of the first base layer and the second base layer is an oriented polyethylene (OPE) film or an oriented polypropylene (OPP) film.

Embodiment 18: The multilayer packaging film according to Embodiment 17, wherein one or more of the oriented polyethylene (OPE) film or the oriented polypropylene (OPP) film is formed by one or more of a sequential stretching process or a simultaneous stretching process.

Embodiment 19: The multilayer packaging film according to Embodiment 18, wherein the simultaneous stretching process is one or more of a linear motor simultaneous stretching process, a double bubble process, or a triple bubble process.

Embodiment 20: The multilayer packaging film according to Embodiment 17, wherein the polyolefin film comprises a biaxially oriented polypropylene (BOPP) film.

Embodiment 21: The multilayer packaging film according to Embodiment 20, wherein the biaxially oriented polypropylene (BOPP) film is formed by a linear motor simultaneous stretching process.

Embodiment 22: The multilayer packaging film according to Embodiment 17, wherein the polyolefin film comprises one or more of a machine direction oriented polyethylene (MDOPE) film, a machine direction oriented polypropylene (MDOPP) film, a cast film or a blown film.

Embodiment 23: The multilayer packaging film according to Embodiment 22, wherein the polyolefin film comprises the machine direction oriented polypropylene (MDOPP) film.

Embodiment 24: The multilayer packaging film according to any previous embodiment, wherein the inorganic coating of one or more of the first base layer or the second base layer comprises silicon oxide.

Embodiment 25: The multilayer packaging film according to Embodiment 24, wherein the inorganic coating of one or more of the first base layer or the second base layer has a gas barrier coating thereon.

Embodiment 26: The multilayer packaging film according to Embodiment 25, wherein gas barrier coating comprises one or more of a hydroxyl group-containing polymer compound, a metal alkoxide, a silane coupling agent, and hydrolyzates thereof.

Embodiment 27: The multilayer packaging film according to any previous embodiment, wherein each of the first base layer and the second base layer have a thickness in a range of from 10 micron to 40 micron.

Embodiment 28: The multilayer packaging film according to any previous embodiment, wherein the sealing layer has a thickness of less than or equal to 120 micron.

Embodiment 29: The multilayer packaging film according to any previous embodiment, wherein oxygen transmission rate is measured before and after retort using the method disclosed in ASTM F1927.

Embodiment 30: The multilayer packaging film according to any previous embodiment, further comprising an adhesive layer between one or more of the first base layer and second base layer, or the second base layer and the sealing layer.

Embodiment 31: The multilayer packaging film according to Embodiment 30, wherein the adhesive layer comprises polyurethane.

Embodiment 32: The multilayer packaging film according to any one of Embodiments 30 through 31, wherein the adhesive layer has a thickness in a range of from 2 micron to 4 micron.

Embodiment 31: The multilayer packaging film according to any previous embodiment, wherein the sealing layer has a seal initiation temperature less than or equal to 110° C.

Embodiment 32: The multilayer packaging film according to any previous embodiment, wherein the sealing layer comprises polypropylene.

Embodiment 33: A retort pouch formed from the multilayer packaging film according to any previous embodiment.

1. A multilayer packaging film comprising:
a first base layer comprising a polyolefin film;
a second base layer on the first base layer, the second base layer comprising a polyolefin film; and
a sealing layer on the second base layer, the sealing layer comprising a polyolefin film,
wherein one or more of the first base layer or the second base layer comprises an inorganic coating thereon, and wherein the second base layer has a shrinkage value that is greater than 5% measured using the method disclosed in ASTM D2732-03.

2. The multilayer packaging film according to claim 1, wherein the shrinkage value of the second base layer is greater than or equal to a shrinkage value of the first base layer.

3. The multilayer packaging film according to claim 1, wherein the shrinkage value of the second base layer is greater than or equal to a shrinkage value of the sealing layer.

4. A multilayer packaging film comprising:
a first base layer comprising a polyolefin film;
a second base layer on the first base layer, the second base layer comprising a polyolefin film; and
a sealing layer on the second base layer, the sealing layer comprising a polyolefin film,
wherein one or more of the first base layer or the second base layer comprises an inorganic coating thereon, and a shrinkage value of the second base layer is less than a shrinkage value of the first base layer.

5. The multilayer packaging film according to claim 4, wherein the second base layer has a shrinkage value that is less than or equal to 5% measured using the method disclosed in ASTM D2732-03.

6. The multilayer packaging film according to claim 4, wherein the shrinkage value of the second base layer is greater than or equal to a shrinkage value of the sealing layer.

7. A multilayer packaging film comprising:
a first base layer comprising a polyolefin film;
a second base layer on the first base layer, the second base layer comprising a polyolefin film; and
a sealing layer on the second base layer, the second base layer comprising a polyolefin film,
wherein one or more of the first base layer or the second base layer comprises an inorganic coating thereon, wherein the second base layer has a shrinkage value that is greater than 5% measured using the method disclosed in ASTM D2732-03, and the shrinkage value of the second base layer is less than a shrinkage value of the first base layer.

8. The multilayer packaging film according to claim 7, wherein the shrinkage value of the second base layer is greater than or equal to a shrinkage value of the sealing layer.

9. (canceled)

10. The multilayer packaging film according to claim 1, wherein the difference in shrinkage value of the first base layer and the second base layer is greater than or equal to 0.3%.

11. The multilayer packaging film according to claim 1, wherein the difference in shrinkage value of the second base layer and the sealing layer is greater than or equal to 0.5%.

12. The multilayer packaging film according to claim 1, wherein the shrinkage value of the sealing layer is greater than or equal to 2%.

13. The multilayer packaging film according to claim 1, wherein the shrinkage value of each of the first base layer, the second base layer, and the sealing layer is measured in a machine direction (MD) according to Formula 1:
$$\frac{MD ( before heating ) - MD ( after heating )}{MD ( before heating )} ⋆ 100 \qquad ( 1 )$$

14. The multilayer packaging film according to claim 1, wherein the shrinkage value of each of the first base layer, the second base layer, and the sealing layer is measured using the method disclosed in ASTM D2732-03.

15. The multilayer packaging film according to claim 1, wherein the shrinkage value of each of the first base layer, the second base layer, and the sealing layer is measured after heating at 120° C. for 15 minutes.

16. The multilayer packaging film according to claim 1, wherein the shrinkage value of each of the first base layer, the second base layer, and the sealing layer is measured after heating at 127° C. for 50 minutes.

17. The multilayer packaging film according to claim 1, wherein the polyolefin film of each of the first base layer and the second base layer is an oriented polyethylene (OPE) film or an oriented polypropylene (OPP) film.

18. The multilayer packaging film according to claim 17, wherein one or more of the oriented polyethylene (OPE) film or the oriented polypropylene (OPP) film is formed by one or more of a sequential stretching process or a simultaneous stretching process.

19. The multilayer packaging film according to claim 18, wherein the simultaneous stretching process is one or more of a linear motor simultaneous stretching process, a double bubble process, or a triple bubble process.

20. The multilayer packaging film according to claim 17, wherein the polyolefin film comprises a biaxially oriented polypropylene (BOPP) film.

21.-34. (canceled)

35. A retort pouch formed from the multilayer packaging film according to claim 1.
